(19) United States
(12) Patent Application Publication
(10) Pub. No.: US 2009/0308891 A1
(43) Pub. Date: Dec. 17, 2009

(54) Cartridge

(75) Inventors: Alexander Bublewitz, Herborn (DE); Matthias Suchan, Hachenburg (DE)

Correspondence Address: COLLARD & ROE, P.C., 1077 NORTHERN BOULEVARD, ROSLYN, NY, 11576, US

(73) Assignee: Kettenbach GmbH & Co. KG

(21) Appl. No.: 11/990,674

(22) PCT Filed: Aug. 26, 2006
(86) PCT No.: PCT/EP2006/008385

§ 371 Date: Aug. 13, 2009

(30) Foreign Application Priority Data
Sep. 3, 2005 (DE) 10 2005 041 962.3

(51) Int. Cl. B67D 5/52; B65D 81/32; B65D 83/00

(52) U.S. Cl. 222/137; 222/145.6; 222/47

(57) ABSTRACT

The invention relates to a cartridge having at least one tube (3a, 3b), particularly a circular cylindrical tube. At least one outlet opening (11a, 11b) is provided in the side wall of the tube. Furthermore, a closure piston (10a, 10b) and a dispensing piston (4a, 4b) that can be adjusted by means of a piston rod are disposed, in sealing and displaceable manner, spaced apart from one another in such a manner that a chamber for accommodating substances that are capable of flow and/or pasty substances is formed between the closure piston and the dispensing piston (4a, 4b). In this connection, the closure piston (10a, 10b) can be displaced between a closure position in which the closure piston is positioned between the dispensing piston and the outlet opening (11a, 11b), to block a flow connection between the chamber and the outlet opening (11a, 11b), and a dispensing position that releases the flow connection between the chamber and the outlet opening. The outlet opening (11a, 11b) has a height (h₂), in the axial direction of the tube (3a, 3b), beginning at the axially front end of the tube (3a, 3b) that faces away from the dispensing piston (4a, 4b), which is greater than the axial height (h₁) of the closure piston (10a, 10b)

The invention relates to a cartridge, particularly for storing and dispensing pasty substances or substances capable of flow, having at least one tube, for example a circular cylindrical tube, in which, in each instance, a closure piston and a dispensing piston that can be adjusted by means of a piston rod are disposed, in sealing and displaceable manner, spaced apart from one another in such a manner that a chamber for accommodating substances is formed between the dispensing piston and the closure piston. In this connection, an outlet opening is provided in each tube.

In the dental sector, in particular, it is usual to store and transport materials in cartridges, from which these can be dispensed by way of a piston. Thus, a double cartridge is known from DE 100 38 882 A1, for example, in which two components for producing an impression mass are directly accommodated in the cartridges. A double cartridge structured in the manner of a syringe, in whose chambers, which are oriented parallel to one another, two substances to be mixed with one another are accommodated, is described in EP 1 426 017 A2. The two chambers have an opening at one end, in each instance, which openings are sealed off by means of a closure part, for transport and storage.

In order to activate this double cartridge, the closure part must be pressed into the chambers, so that a dispensing channel provided in the closure part is released. This method of procedure must be explained to the user before the first activation of such a double cartridge. Furthermore, this known double cartridge can be used for only a single dose (unidose), and must be disposed of afterwards.

Alternatively to this, it is also known to pack such materials in tubular bags, which can be placed into the cartridges, which can then be used multiple times. However, such systems must be hermetically sealable, as much as possible, for transport and storage, since the components can react with one another and/or with the surroundings, and, on the other hand, must be easy to open for a user. For this purpose, the tubular bags must be stabbed open or cut open, without the components contaminating the reusable cartridges when this is done. In some cases of use, this has proven to be difficult.

Furthermore, in DE 101 40 704 A1, a double chamber syringe is proposed, in which a center plug is provided in addition to a dispensing plug, by means of which the double chamber syringe is divided into two chambers in which two components can be stored separate from one another. To apply these components, pressure is exerted on one of the components, by way of the dispensing plug, in such a manner that the center plug is displaced into a position in which it releases a bypass channel formed in the double chamber syringe. In this open position, the center plug is stopped by means of a projection on the inside of the syringe. The two substances can mix with one another, particularly if they are well miscible liquids, and be dispensed from the double chamber syringe together. Such double chamber syringes are also suitable only for one-time use, however, if the substances accommodated in the chambers react with one another after being mixed and harden, for example. Furthermore, mixing of the two substances accommodated in the double chamber syringe is felt to be in need of improvement, particularly if these are not liquids.

A cartridge of the type stated initially is known from WO 2005/016170 A2. In the case of this known double cartridge, the closure pistons have a height, in the axial direction, which is greater than the axial height of the outlet opening, in each instance, in order to prevent the substance accommodated in the chamber from being able to flow past the closure piston, through the outlet opening, in the sense of a bypass channel, and reach the side of the closure piston that faces away from the dispensing piston. This would make displacement and complete opening of the outlet opening more difficult, since a crosspiece is provided on the front end of the tube, facing away from the dispensing piston, which crosspiece is followed, in the axial direction, by the outlet opening. Furthermore, the front ends of the tubes have to be opened in order to vent this hold-up volume. Therefore there is a possibility that germs will penetrate into the known cartridge, in the closure line. Because of the comparatively large piston and the hold-up volume, the axial construction space of the cartridge is increased.

In contrast with this, it is the task of the present invention to make available as compact as possible a cartridge of the type stated initially, in which the substances can be stored well sealed with regard to one another and with regard to the surroundings, without making dispensing from the cartridge more difficult. At the same time, the cartridge is supposed to be particularly simple to open.

This task is accomplished, according to the invention, essentially in that the outlet opening has a height, in the axial direction of the tube, beginning at the axially front end of the tube that faces away from the dispending piston, which is greater than the axial height of the closure piston. If the height of the outlet opening in the axial direction of the tube is greater than the height of the closure piston in the axial direction of the tube, the substance accommodated in the chamber can flow past the closure piston in the sense of a bypass channel, through the outlet opening, if the piston is displaced in the tube toward the front end, i.e. into the dispensing position. Since the outlet opening runs in the axial direction, starting at the front end of the tube, it is unimportant whether or not the substance might reach the side of the closure piston that faces away from the dispensing piston when this happens. The residual amount of the substance disposed between the closure piston and the front end of the tube is also dispensed out of the tube through the outlet opening, since, according to the invention, specifically no crosspiece provided in accordance with the state of the art, or the like, hinders dispensing of the substance. By means of the configuration of the cartridge according to the invention, the axial height of the closure piston and the hold-up volume of the tube can be minimized, so that the cartridge requires only little construction space. Furthermore, no complicated configuration of a crosspiece adapted to the construction height of the piston, and no adaptation of the height of the piston to the outlet opening are required.

In this connection, the outlet opening can be formed by at least one slit running in the axial direction of the tube, the height of which slit, in the axial direction, is preferably greater than its width. In this way, the piston is guided well in the tube laterally. At the same time, the opening cross-section of the outlet opening, which is available for dispensing the substances, is sufficiently great. In this connection, the outlet opening does not have to be configured as a straight-line slit. Instead, it can also run in a curve, in wave shape, in helical shape, or angled away from the axially front end in the direction toward the axially rear end. Furthermore, the outlet opening can be formed by means of multiple slits having the same or different shape, disposed behind and/or next to one another.

Unintentional opening, i.e. activation of the cartridge can be avoided in that means for releasable fixation of the closure piston in the closure position are provided in each tube and/or each closure piston. Thus, the closure pistons also cannot unintentionally slip from the closure position into the dispensing position due to vibrations during transport, but rather, at first a slight resistance must be overcome in order to activate the cartridge according to the invention, until the closure pistons slide out of their closure position. The releasable fixation of the closure piston can be implemented, for example, in that these are held against the inside wall of the tube, in each instance, in their closure position by means of a projection, an edge, a join, a groove, or the like, in each instance, or by means of a similar change in cross-section.

Preferably, metering markings and/or means for releasable fixation of the dispensing piston in the closure position are provided on at least one dispensing piston, on at least one tube, and/or on at least one piston rod. The metering markings can be configured, for example, by means of catch noses and catch notches, so that an optical, acoustical and/or tactile monitoring possibility for a user is presented. In this manner, it is made easy to dispense a predetermined amount of substance from the cartridge. The means for releasable fixation of the dispensing piston in the closure position can also be formed by means of a catch, a change in cross-section within the tube, or the like, in order to prevent the piston rods, i.e. the dispensing piston from being unintentionally activated during transport or storage. Alternatively, it is also possible to fix the dispensing piston or the piston rods in place by way of a planned breaking point, which is separated when the cartridge is activated.

If a finger handle and/or an accommodation for a dispensing device is provided on at least one tube, the cartridge according to the invention can be activated manually, in the manner of a syringe, or can be emptied by machine, by means of a dispensing device.

In order to prevent dirt from penetrating and/or the closure piston from falling out, the tubes can be closed at their ends that face away from the piston rods. Alternatively to this, the tubes can be open at their face ends that face away from the piston rods, in such a manner that the closure pistons can be pressed out of the tubes; this can be advantageous, in particular, in the case of very small cartridges.

According to a preferred embodiment of the invention, it is provided that the closure piston has at least one passage opening, and that the tube that is assigned to this closure piston and/or the outlet opening has/have at least one projection. In this connection, the passage opening and the projection are adapted to one another in terms of their shape, in such a manner that the closure piston can be displaced between a closure position in which the chamber is closed, and a dispensing position in which the chamber stands in a flow connection with the outlet opening by means of the passage opening. In order to dispense the substance from the cartridge, the dispensing piston merely has to be displaced by means of the piston rod, so that the closure piston is displaced into the dispensing position by means of the pressure that the substance accommodated in the chamber transfers from the dispensing piston. The cartridge can therefore be opened, i.e. activated intuitively by a user, in that pressure is exerted on the piston rod, as is usual also for syringes, for example.

In a further development of the idea of the invention, it is provided that two tubes are connected with one another to form a double cartridge, whereby the outlet openings of the two tubes preferably open into a common outlet connector. This cartridge according to the invention is therefore suitable for separate storage and common dispensing of two components from which a dental impression mass, for example, or the like is mixed. The outlet openings can be provided between the tubes and the outlet connector, or open into channels disposed on the sides of the tubes, for example. Furthermore, it is also possible to provide a separate outlet connector for each tube.

In order to make reverse contamination, i.e. reverse flow of the substance accommodated in one chamber of the cartridge into the other chamber, more difficult, two separate channels preferably run in the outlet connector, which channels are connected with one of the two outlet openings, in each instance. In this way, the path from one chamber into the other is made longer, so that the substances accommodated in the cartridge cannot already be mixed with one another in the chambers as the result of small pressure differences, which could cause the outlet openings to become plugged up. Alternatively to this, it is possible to connect each tube with a separate outlet connector.

If the channels have a different length and/or different volumes, these can be adapted to the different viscosities or initial running properties of the substances. In this way, it can be prevented, for example, that one substance exits out of the outlet connector before the other. Therefore the mixing result is already optimal even at the beginning of the dispensing process.

According to a preferred embodiment of the invention, the two tubes are connected with one another in one piece, whereby the tubes can have a common center wall in which the two outlet openings are provided. In a further development of this idea of the invention, the two piston rods can also be connected with one another. In this way, it is possible to dispense the substances accommodated in the two chambers formed by the tubes in particularly uniform manner. Preferably, the two piston rods form a common double piston rod having a central catch rod to which a catch nose provided between the tubes is assigned. In this connection, the double piston rod has catch elements on only one side, according to a preferred embodiment, whereby catch noses between the tubes are also disposed only on one side. In this way, it is possible, in the case of the essentially mirror-symmetrical structure of the double piston rod, to either introduce it between the tubes in such a manner that the catch elements and the catch noses enter into contact with one another, or to avoid engagement if the double piston rod is inserted rotated about the longitudinal axis by 180°.

A mixer and/or an application device can be provided at the outlet connector of the cartridge according to the invention. These can either be formed in one piece with the outlet connector, or can be releasably attached to it. In the case of use of this cartridge for multiple dosages (multidose), the mixer or the application device can remain on the cartridge after use, in each instance, thereby causing the components that have been mixed with one another to harden in the mixer, for example. The hardened mixture therefore forms a closure for the cartridge after its first activation. For renewed use, the old mixer or the like must be removed and replaced with a new one.

In order to be able to implement different mixture ratios of the substances accommodated in the chambers of the cartridge, as is frequently the case for base components and catalyst components, for example, the tubes of the cartridge can have different diameters.

According to a preferred embodiment of the invention, the two closure pistons and/or the two dispensing pistons are disposed offset relative to one another in the closure position, in the axial direction of the tubes. In this way, the result can be achieved that the closure piston of a substance that tends to advance faster reaches its dispensing position only after the closure piston of the other substance, so that the two components essentially exit from the outlet connector at the same time, and therefore a good mixture ratio is achieved right from the beginning.

The piston rods can be rigidly connected with the dispensing pistons assigned to them. In order to prevent faster advance of a substance, it is also possible that only one dispensing piston is firmly connected with the piston rod assigned to it, while the second piston rod is configured to be somewhat shorter and does not stand in contact with the dispensing piston assigned to it, in the closure position. When the cartridge is activated, at first only the dispensing piston that is firmly connected with the piston rod is activated, and the second piston rod impacts the dispensing piston only after a short setting path, so that then, both substances are dispensed from the cartridge.

According to another embodiment of the invention, a cartridge having at least two tubes is provided, which form a chamber, in each instance, whereby the chamber walls have different permeability, particularly different air permeability. This can be achieved either by means of different material properties of the chamber walls, or in that one of the chambers is sealed off, particularly with regard to the surroundings, by means of a tubular bag accommodated in it, for example. The different permeability of the chambers can lower the production costs of a cartridge, on the one hand, if particularly sealing properties are required for only one chamber, and, on the other hand, can permit an air exchange or the like with the surroundings, which is desirable in some cases.

In the following, the invention will be explained in greater detail using exemplary embodiments and making reference to the drawing. In this connection, all of the characteristics described and/or shown in the illustrations form the object of the invention, in themselves or in any desired combination, independent of how they are summarized in the claims or their antecedents.

The drawing schematically shows:

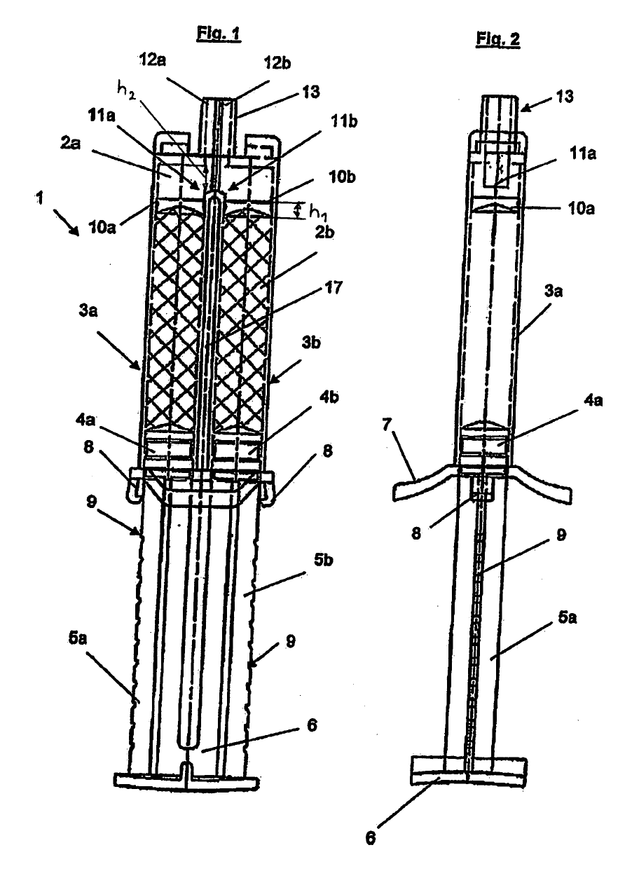

FIG. 1 in a sectional view, a double cartridge according to a first embodiment of the invention, in its delivery position or closure position,

FIG. 2 in a side view, the double cartridge according to FIG. 1,

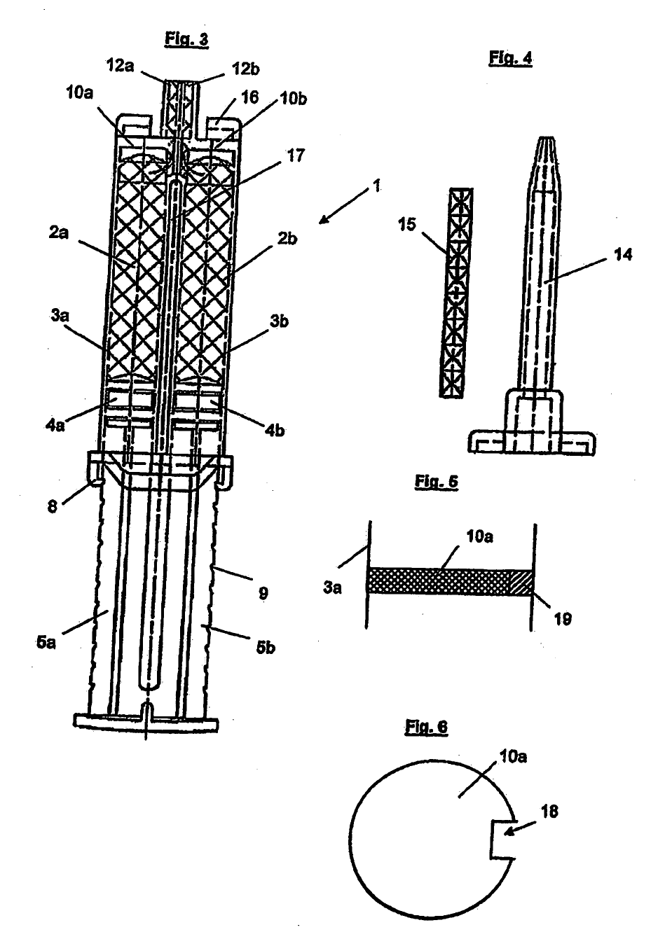

FIG. 3 the double cartridge according to FIG. 1 in its activated dispensing position,

FIG. 4 a mixing tube sleeve that can be set onto the double cartridge according to FIG. 1,

FIG. 5 in a sectional view, a detail of a double cartridge according to a second embodiment of the invention, in its closure position,

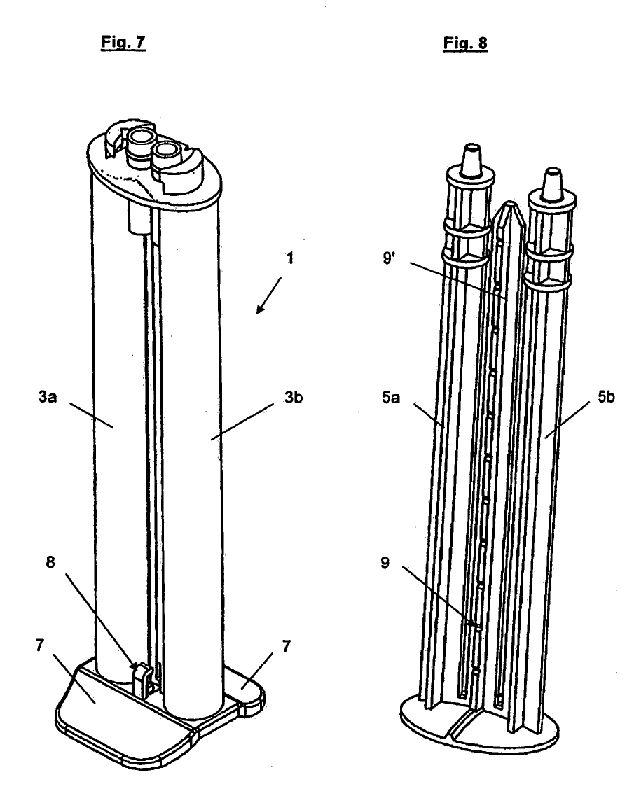

FIG. 6 in a top view, the closure piston according to FIG. 5,

FIG. 7 in a perspective view, a double cartridge according to another embodiment of the invention, and

FIG. 8 in a perspective view, a piston rod assembly for the double cartridge according to FIG. 7.

The double cartridge 1 shown in FIGS. 1 to 3 is formed by two cartridges 2a, 2b that are connected with one another in one piece. Each of these cartridges 2a, 2b consists of a tube 3a or 3b, respectively, which is closed at the upper end in the figures, and open on the opposite side.

A dispensing piston 4a, 4b is provided in the tubes 3a, 3b, in each instance, which closes off the open end of the tubes, forming a seal, and can be displaced in the tubes 3a and 3b, respectively, by means of a piston rod 5a, 5b. In this connection, the two piston rods 5a, 5b are connected with one another in one piece, by way of a common crosspiece 6, so that the dispensing pistons 4a and 4b fixed in place on the piston rods can be activated at the same time.

As is evident from FIG. 2, finger handles 7 are provided at one end of the tubes 3a, 3b, so that the double cartridge 1 can be activated similar to a syringe. Furthermore, catch noses 8 are provided at the ends of the tubes 3a, 3b, which come into engagement with catch notches 9 on the piston rods 5a, 5b, when the dispensing pistons are pushed into the tubes 3a, 3b by means of the piston rods 5a, 5b. In this connection, the catch noses 8 and the catch notches 9 are configured in such a manner that the catches can easily be overcome manually, in order to obtain acoustical or tactile feedback, for example, if the dispensing pistons 4a, 4b have been displaced within the tubes 3a, 3b by a defined amount. The catch noses 8 and catch notches 9 consequently serve for precise metering.

Furthermore, a closure piston 10a, 10b is accommodated in each of the tubes 3a, 3b, in each instance, forming a seal and being displaceable, so that chambers are formed between the closure pistons 10a, 10b and the dispensing pistons 4a, 4b, in each instance. In this connection, the closure pistons 10a, 10b are shown in their closure position in FIGS. 1 and 2, while the closure pistons 10a, 10b are displaced into their dispensing position in FIG. 3.

An outlet opening 11a, 11b is provided in the side wall of the tubes 3a, 3b, in each instance, which lies between the upper closed end of the tubes 3a, 3b and the closure pistons 10a, 10b in the closure position of the closure pistons. In this connection, the outlet openings 11a, 11b are configured as slits that begin at the axially front end of the tubes 3a, 3b, facing away from the dispensing piston 4a, 4b, in each instance, and run essentially axially toward the rear (down in FIGS. 1 to 3). The height h₁ of the closure pistons is smaller, measured in the axial direction of the tubes, than the height h₂ of the outlet openings in the axial direction of the tubes. Thus, the outlet openings 11a, 11b release a flow connection out of the chambers, when the closure pistons 10a, 10b have been displaced into their upper dispensing position in FIG. 3, i.e. at least close to the front end of the tubes.

A channel 12a, 12b branches off from the outlet openings 11a, 11b, in each instance, which opens into a common outlet connector 13 for the double cartridge 1. The outlet connector 13 thus stands in connection with the chambers that are defined between the dispensing pistons 4a, 4b and the closure pistons 10a, 10b, in each of the tubes 3a, 3b, in the dispensing position, and in which a pasty substance, for example, can be stored. In deviation from the embodiment shown, having a common outlet connector 13, a separate outlet connector can also be provided for each tube of the double cartridge, which connector forms a channel that leads from the outlet openings 11a, 11b to a mixer or the like.

On the inside wall of the tubes 3a, 3b, projections or the like can be provided, in order to releasably fix the closure pistons 10a, 10b in their closure position. If pressure is exerted on the dispensing pistons 4a, 4b by way of the piston rods 5a, 5b, in the closure position shown in FIGS. 1 and 2, this pressure is transferred to the closure pistons 10a, 10b, by means of the substances accommodated in the chambers, so that these pistons are displaced upward in the figures. In this connection, the closure pistons 10a, 10b move past the outlet openings 11a, 11b, until they completely release the outlet opening 11a, 11b in the dispensing position shown in FIG. 3. The substances accommodated in the chambers can thus be dispensed from the double cartridge 1 through the outlet opening 11a, 11b and the channels 12a, 12b, by means of continued pressure on the piston rods 5a, 5b. The first opening, i.e. activation of the double cartridge 1 thus takes place intuitively, by means of activation as in the case of a conventional syringe.

In the case of known cartridges, a hold-up volume is generally provided in the face region of the tubes, adjacent to the outlet openings, because the outlet openings do not reach directly all the way to the face wall of the cartridge. Since no crosspiece or the like is provided in the vicinity of the face end of the two tubes, according to the embodiment shown in FIGS. 1 and 2, the hold-up volume can be reduced, in the case of the cartridge according to the invention, as compared with the cartridge systems known from the prior art, without any additional measures.

A mixing tube sleeve 14 shown in FIG. 4, for example, can be set onto the outlet connector 13, which sleeve forms a static mixer, together with a mixing helix 15 accommodated in it. Alternatively to this, a driven dynamic mixer or another suitable application device can also be attached to the face end of the double cartridge 1 and/or the outlet connector 13. For this purpose, suitable attachment means 16, for example a bayonet closure, a thread, or the like, can be provided on the face side of the double cartridge 1.

In the case of the embodiment of the double cartridge 1 shown in FIGS. 1 to 3, the channels 12a, 12b run proceeding from the outlet openings 11a, 11b all the way to the end of the outlet connector 13 in the center wall 17, which connect the two cartridges 2a, 2b with one another. As is particularly evident from FIGS. 1 and 3, the center wall 17 between the tubes 3a, 3b is comparatively wide in the lower region of the figures, so that the two tubes 3a, 3b are positioned spaced apart from one another. In contrast, the center wall 17 narrows in the upper region of the figures, in the vicinity of the outlet openings 11a, 11b, in such a manner that it forms only a thin partition between the channels 12a, 12b.

As an alternative to this embodiment, it is also possible to allow the channels 12a, 12b to run turned by 90° about the central axis of the double cartridge, so that the channels lie behind one another in the plane of the drawing. The tubes can then lie more closely against one another.

In the embodiment shown, the center wall 17 extends so far into the outlet connector 13 that the channels 12a, 12b are conducted separate from one another all the way to their end. In this connection, the inlet connectors of a mixer or the like, not shown, can advantageously be inserted into the channels 12a, 12b of the outlet connector 13, or vice versa.

As shown in detail in FIGS. 5 and 6, the closure pistons 10a, 10b, only one of which is shown, have a passage opening 18, in each instance, according to another embodiment. Furthermore, a projection 19 is provided on the inside wall of the tubes 3a, 3b, in each instance, whose shape and size is adapted to the passage opening 18, so that the edge of the passage opening 18 lies against the projection 19 in the closure position, forming a seal. Thus, the closure pistons 10a, 10b close the chamber off in their closure position, forming a seal. According to the invention, it is also possible, alternatively to the embodiment shown in FIGS. 5 and 6, particularly in the case of thick-walled tubes, to provide a groove-like recess, for example, in the tubes, which recess runs in the axial direction of the tubes, while the closure pistons are equipped with a corresponding projection.

If pressure is exerted on the dispensing pistons 4a, 4b in the closure position, by way of the piston rods 5a, 5b, this pressure is transferred to the closure pistons 10a, 10b, by means of the substances accommodated in the chambers, so that these pistons are displaced downward in FIG. 5. In this connection, the closure pistons 10a, 10b come loose from the projections 19, so that a substance can flow out of the chamber through the passage openings 18, which have been released, into the outlet openings 11a, 11b. The substances accommodated in the chambers can thus be dispensed from the double cartridge through the outlet opening 11a, 11b and the channels 12a, 12b, by means of continued pressure on the piston rods 5a, 5b. The first opening, i.e. activation of the double cartridge thus also takes place intuitively, by means of activation as in the case of a conventional syringe.

The cartridges described above are particularly suitable for storing and dispensing pasty substances or substances capable of flow, for the dental sector. However, the cartridges are also suitable for use in other technical sectors, for example for administering medications or for storing and dispensing pasty construction materials. Depending on the conditions of use, it can also be sufficient to provide only one cartridge, or more than two cartridges connected with one another.

Another embodiment of a double cartridge 1 having two connected tubes 3a, 3b and a piston rod assembly for them is shown in FIGS. 7 and 8. The piston rod assembly has two piston rods 5a, 5b connected with one another, and a catch rod 9′ formed in one piece with them, which is disposed between the two piston rods. The catch rod 9′ has a cross-shaped cross-section, which is disposed in a corresponding opening that lies in the crosspiece region of the double cartridge, between the finger handles 7. A catch nose 8 is also provided there, in such a manner that it interacts with catch notches 9 on the catch rod 9′, as metering markings, in order to give a user optical, acoustical and/or tactile monitoring of the metered amount. h₂ height of the outlet opening in the axial direction

1. Cartridge having at least one tube, particularly a circular cylindrical tube, in the side wall of which at least one outlet opening is provided, and in which a closure piston and a dispensing piston that can be adjusted by means of a piston rod are disposed, in sealing and displaceable manner, spaced apart from one another in such a manner that a chamber for accommodating substances that are capable of flow and/or pasty substances is formed between the closure piston and the dispensing piston, whereby the closure piston can be displaced between a closure position in which the closure piston is positioned between the dispensing piston and the outlet opening, to block a flow connection between the chamber and the outlet opening, and a dispensing position that releases the flow connection between the chamber and the outlet opening, wherein the outlet opening (11a, 11b) has a height (h₂), in the axial direction of the tube (3a, 3b), beginning at the axially front end of the tube (3a, 3b) that faces away from the dispensing piston (4a, 4b), which is greater than the axial height (h₁) of the closure piston (10a, 10b).

2. Cartridge according to claim 1, wherein each outlet opening (11a, 11b) is formed by at least one slit running in the axial direction of the tube (3a, 3b), whose height (h₂), in the axial direction, is greater than its width.

3. Cartridge according to claim 1, wherein means for releasable fixation of the closure piston (10a, 10b) in the closure position are provided on the tube (3a, 3b) and/or the closure piston (10a, 10b).

4. Cartridge according to claim 1, wherein metering markings (8, 9) and/or means for releasable fixation of the dispensing piston (4a, 4b) in the closure position are provided on the dispensing piston (4a, 4b), on the tube (3a, 3b), and/or on the piston rod (5a, 5b).

5. Cartridge according to claim 1, wherein at least one finger handle (7) and/or an accommodation for a dispensing device is provided on the tube (3a, 3b).

6. Cartridges according to claim 1, wherein the tubes (3a, 3b) are closed off at their ends that face away from the piston rods (5a, 5b).

7. Cartridges according to claim 1, wherein the tubes (3a, 3b) are open at their ends that face away from the piston rods (5a, 5b), in such a manner that the closure pistons (10a, 10b) can be pushed out of the tubes (3a, 3b).

8. Cartridges according to claim 1, wherein the closure piston (10a, 10b) has at least one passage opening (18), and that wherein the tube (3a, 3b) that is assigned to this closure piston (10a, 10b) and/or the outlet opening (11a, 11b) has/have at least one projection (19), whereby the passage opening (18) and the projection (19) are adapted to one another in terms of their shape, in such a manner that the closure piston (10a, 10b) can be displaced between a closure position in which the chamber is closed, and a dispensing position in which the chamber stands in a flow connection with the outlet opening (11a, 11b) by means of the passage opening (18).

9. Double cartridge composed of two cartridges, connected with one another, according to claim 1, wherein the outlet openings (11a, 11b) of the two cartridges (2a, 2b) open into a common outlet connector (13).

10. Double cartridge according to claim 9, wherein two separate channels (12a, 12b) run in the outlet connector (13), which channels are connected with one of the two outlet openings (11a, 11b), in each instance.

11. Double cartridge according to claim 10, wherein the channels (12a, 12b) have a different length and/or different volumes.

12. Double cartridge according to claim 9, wherein the tubes (3a, 3b) that form the two cartridges (2a, 2b) are connected with one another in one piece, particularly by way of a common center wall (17) in which the two outlet openings (11a, 11b) are provided, and that wherein the two piston rods (5a, 5b) are connected with one another.

13. Double cartridge according to claim 12, wherein the two piston rods (5a, 5b) form a common double piston rod having a central catch rod (9′) to which a catch nose (8) provided between the tubes (3a, 3b) is assigned.

14. Double cartridge according to claim 13, wherein the catch rod (9′) has catch elements on only one side, and that catch noses (8) between the tubes (3a, 3b) are disposed only on one side.

15. Double cartridge according to claim 9, wherein the outlet connector (13) can be connected with a mixer (14, 15) and/or an application device.

16. Double cartridge according to claim 9, wherein the two closure pistons (10a, 10b) and/or the two dispensing pistons (4a, 4b) are disposed offset relative to one another in the closure position, in the axial direction of the tubes.

17. Cartridge according to claim 1, having two tubes (3a, 3b) that form a chamber, in each instance, wherein the chamber walls have different permeability, particularly different air permeability.
